(19) United States
(12) Patent Application Publication
(10) Pub. No.: US 2022/0303237 A1
(43) Pub. Date: Sep. 22, 2022

(54) METHODS AND SYSTEMS FOR SEARCHING CUSTODIAN-BASED DATA BASED ON IMMUTABLE IDENTIFIERS ASSOCIATED WITH CUSTODIAN ACTIONS

(71) Applicant: ProSearch Strategies, Inc., Los Angeles, CA (US)

(72) Inventors: Cyrus Ford-Wilcox, Los Angeles, CA (US); Dong-Soo Paul Park, Los Angeles, CA (US)

(21) Appl. No.: 17/204,137

(22) Filed: Mar. 17, 2021

(51) Int. Cl. H04L 12/58

(52) U.S. Cl. CPC H04L 51/12; H04L 51/08; H04L 51/22; H04L 51/06

(57) ABSTRACT

The present disclosure is directed to systems and methods for searching custodian-based data. The method includes, for example, retrieving custodian-based data associated with multiple custodians; retrieving immutable identifiers associated with one or more custodian actions associated with multiple custodians; generating a query index the custodian-based data at least based on the one or more custodian actions; and searching the custodian-based data based on the query index and the immutable identifiers. The query index can include one or more data items, and each of the data items of the query index is associated with one of the immutable identifiers.

### TECHNICAL FIELD

The present technology is directed to systems and methods for searching custodian-based data. More particularly, systems and methods for searching and querying custodian-based email data are disclosed herein.

### BACKGROUND

Custodian-based data, such as email data, is an important source of information in modern life. For example, the custodian-based data can be used as evidence in litigation. To be able to show that a custodian is aware of and/or whether they have taken actions to obfuscate certain information, the actions of the custodian must be recorded or stored. It can be challenging for traditional data management systems to effectively search or query such custodian actions. Therefore, there is a need and it is advantageous to have an improved method and system to address the foregoing issue.

### BRIEF DESCRIPTION OF THE DRAWINGS

Non-limiting and non-exhaustive examples are described with reference to the following figures.

FIG. 1 is a schematic diagram illustrating a system in accordance with embodiments of the present technology.

FIG. 2 is a schematic diagram illustrating another system in accordance with embodiments of the present technology.

FIG. 3A is a schematic diagram illustrating a data structure of a custodian-based data set in accordance with embodiments of the present technology.

FIG. 3B is a table illustrating a query index of a custodian-based data set in accordance with embodiments of the present technology.

FIG. 4 is a schematic diagram illustrating components in a computing device (e.g., a client device, a server, etc.) in accordance with embodiments of the present technology.

FIGS. 5-7 are flow diagrams showing methods in accordance with embodiments of the present technology.

### DETAILED DESCRIPTION

Various aspects of the disclosure are described more fully below with reference to the accompanying drawings, which form a part hereof, and which show specific exemplary aspects. Different aspects of the disclosure may be implemented in many different forms and should not be construed as limited to the aspects set forth herein. Rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation, or an implementation combining software and hardware aspects. The following detailed description is, therefore, not to be taken in a limiting sense.

The present technology is directed to systems and methods for searching, managing, and querying custodian-based data. In some embodiments, the custodian-based data can include emails, messages, account information, transaction histories, etc. Traditional approaches of managing custodian-based data include storing such data in a file with corresponding metadata. For example, an email can be saved in EML format (also known as “RFC-822” file format), and can be accessed via Microsoft Outlook or Apple Mail. In some embodiments, emails in EML format can include attachments encoded therein in text format.

The metadata of an email in EML format indicates the subject, sender, recipients and date of the email. Such metadata does not provide sufficient information regarding how the email has been accessed, processed, or handled by its custodian (i.e., “custodian actions”) after the custodian receives the email. For example, after the custodian accesses an email, the custodian may try to archive, delete, and/or mark as “unread” that email. In other examples, the custodian may try to assign a flag identifier (e.g., “confidential,” “urgent,” “to be deleted,” “important,” “to be ignored,” etc.) to the email. Traditional metadata of an email (such as in EML format) does not provide information regarding the foregoing custodian actions.

To address this need, the present disclosure provides systems and method for managing custodian-based data and enables an operator to search and/or query the data effectively and efficiently. Generally speaking, for each custodian action performed (or some actions of interests, depending on user preference), the present method can identify the custodian action, generate immutable identifiers (or unchanging identifiers, etc.), and associate them with the custodian-based data. The immutable identifiers can be generated and stored in a practically “real-time” manner. For example, in some embodiments, the immutable identifiers can be generated once per 6, 12, or 24 hours. The generated immutable identifiers record all the identified custodian actions during this time period. The sooner the immutable identifiers are generated after the custodian actions were performed, the less likelihood that the custodian-based data is altered, tampered with, or compromised. By this arrangement, the present method effectively preserves and stores the custodian-based data such that it can be searched, queried, and/or analyzed at a later time (e.g., evidence for litigation).

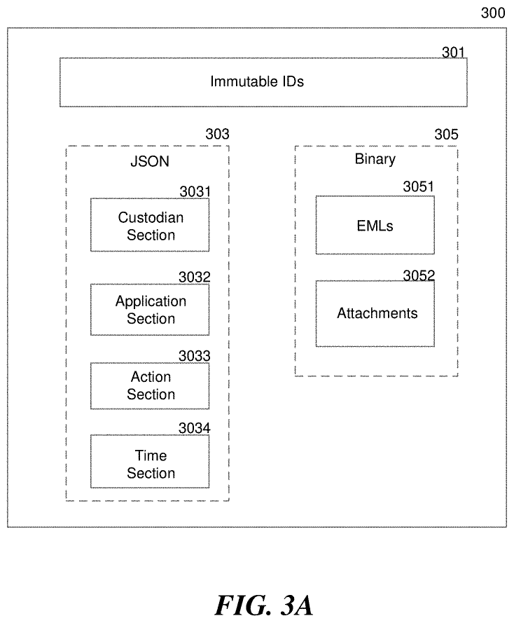

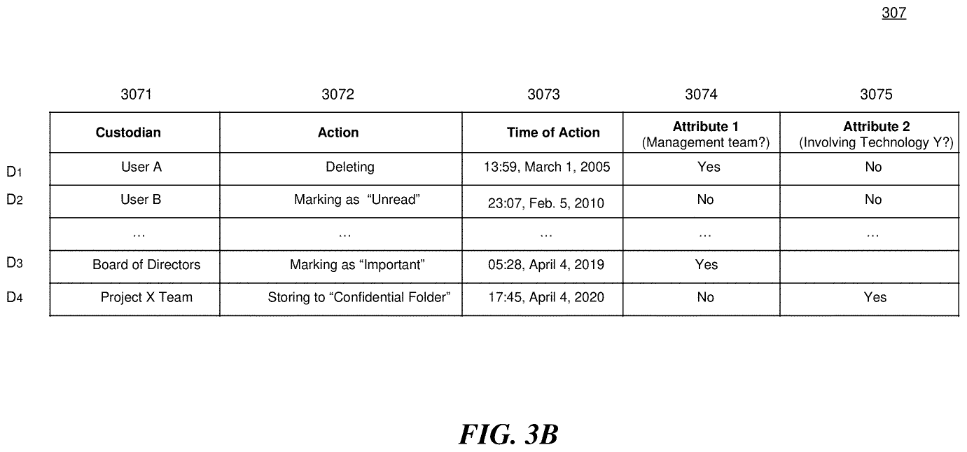

The present method can then store the custodian-based data with the generated immutable identifiers. In some embodiments, the generated immutable identifiers and the custodian-based data can be associated with a query index. Embodiments of the query index are discussed with reference to FIG. 3B. The query index enables an operator to manage, sort, categorize, and prioritize the custodian-based data. By this arrangement, the custodian-based data can be searched in a customized way.

One aspect of the present technology includes enabling an operator to retrieve and store custodian-based data by recording custodian actions that have been performed on the custodian-based data. In some embodiments, the present method includes, for example, (i) retrieving custodian-based data associated with multiple custodians; (ii) analyzing metadata items (which include one or more custodian actions) associated with the custodian-based data, (iii) generating immutable identifiers for the custodian-based data associated with the custodian actions; (iv) generating immutable identifiers for the custodian-based data associated with the custodian actions; and (v) storing the custodian-based data in a raw data form (e.g., in binary form, in American Standard Code for Information Interchange (ASCII) form, etc.).

Another aspect of the present technology includes enabling an operator to query or search custodian-based data based on custodian actions. For example, the operator can search emails from a sender that were read and later marked as “unread” during a certain period of time. In this example, the custodian action can be “accessing an email and later marking it as unread.” In some embodiments, the custodian actions can be defined based on user preferences.

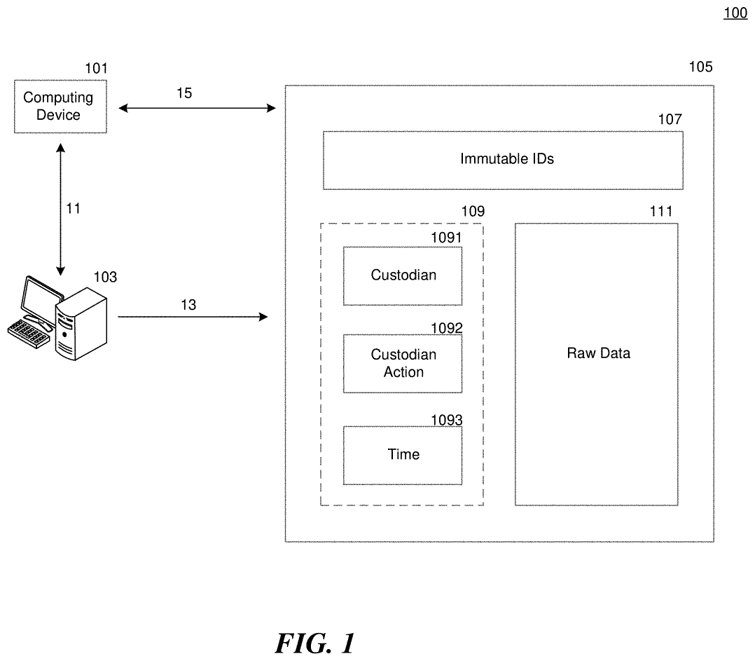

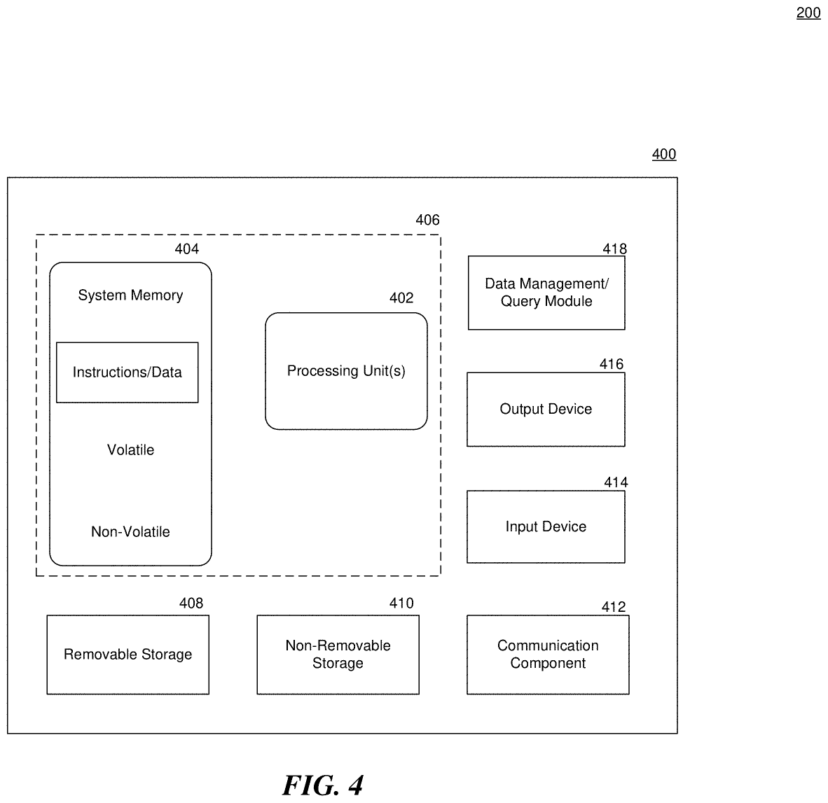

FIG. 1 is a schematic diagram illustrating a system 100 in accordance with embodiments of the present technology. As shown in FIG. 1, the system 100 includes a computing device 101, a source data server 103, and a target data server 105. The computing device 101 is configured to (i) retrieve custodian-based data from the source data server 103, (ii) process the custodian-based data, and (iii) store the processed custodian-based data in the target data server 105. In some embodiments, the computing device 101 can query or search the processed custodian-based data stored in the target data server 105. In some embodiments, the computing device 101 can include one or more processors and memories configured for implementing the foregoing tasks. Embodiments of the computing device 101 are discussed in detail with reference to FIG. 4.

Suitable systems and methods associated with searching processed custodian-based data are further described in co-pending U.S. patent application Ser. No. 17/167,561, filed Feb. 4, 2021, and entitled METHODS AND SYSTEMS FOR CREATING, STORING, AND MAINTAINING CUSTODIAN-BASED DATA, (attorney docket no. 136566-8001.US00) and co-pending U.S. patent application Ser. No. ______, filed ______, and entitled METHODS AND SYSTEMS FOR CUSTODIAN BASED DATA RESTORATION, (attorney docket no. 136566-8003.US00), the disclosures of which are incorporated herein by reference in their entireties.

In some embodiments, the source data server 103 can include an email server, a local/cloud server, and/or other suitable devices that store custodian-based data to be retrieved by the computing device 101. The computing device 101 can first communicate with the source data server 103 to learn what custodian-based data (e.g., emails of employees in Company X) are stored therein and its format (EML files) (e.g., Step 11 shown in FIG. 1). The source data server 103 includes an activity log recording all activities or actions associated with the custodian-based data. The activities and actions can include actions by a custodian (“custodian actions”) performed on the custodian-based data. For example, the custodian-based data can include an email. The custodian of the email can be a sender, a direct recipient, and/or an indirect recipient (e.g., “carbon copied” or “blind carbon copied”). Examples of the custodian actions of the email include deleting the email, archiving the email, assigning a flag identifier to the email (e.g., showing status of the email such as confidential, urgent, to be deleted, important, and/or to be ignored), and attempting to change the status of the email (e.g., marking the email as “unread” after accessing the email).

The computing device 101 can then create an immutable identifier 107 for each of the actions or activities in the activity log in the source data server 103. In some embodiments, the immutable identifiers 107 can be generated by an application implemented in the source data server 103. The computing device 101 then causes the custodian-based data and the immutable identifiers 107 to be stored in the target data server 105 (e.g., Step 13 shown in FIG. 1).

As shown in FIG. 1, the custodian-based data stored in the target data server 105 includes a metadata portion 109 and a raw data portion 111. The metadata portion 109 is indicative of a custodian 1091, a custodian action 1092, and time 1093 that the custodian action was performed. The raw data portion 111 can include the content of the custodian-based data and can be in binary form (e.g., to save storage space). The metadata portion 109 and the raw data portion 111 are associated with the immutable identifier 107, such that the computing device 101 can query or search the custodian-based data stored in the target data server 105 based on the metadata portion 109 (e.g., a search using “custodian,” “custodian action,” and/or “time” as keywords) (e.g., Step 15 shown in FIG. 1). By this arrangement, the system 100 enables an operator to effectively manage, store, and query the custodian data from the source data server 103.

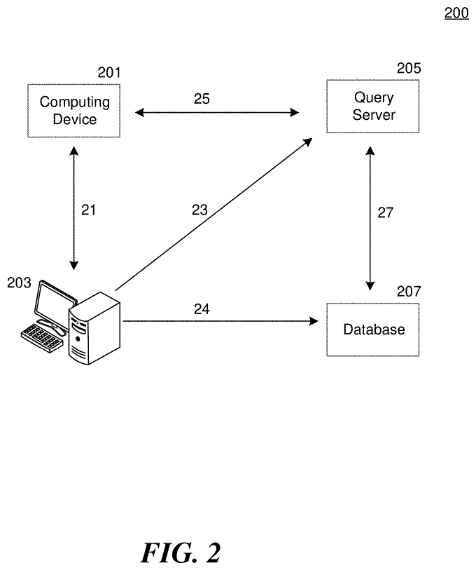

FIG. 2 is a schematic diagram illustrating another system 200 in accordance with embodiments of the present technology. Similar to the system 100 described in FIG. 1, the system 200 includes a computing device 201 and an email data server 203. The system can have (i) a query server 205 configured to handle queries/searches and (ii) a database 207 configured to store raw data.

The computing device 201 can first communicate with the email data server 203 and analyze the email data stored therein (e.g., Step 21 shown in FIG. 2). The email data server 203 includes an activity log recording all activities or actions associated with the email data. The activities and actions can include actions by a custodian (“custodian actions”) performed on the email data. The custodian of the email can be a sender, a direct recipient, and/or an indirect recipient (e.g., “carbon copied” or “blind carbon copied”). Examples of the custodian actions of the email include deleting the email, achieving the email, assigning a flag identifier to the email (e.g., showing status of the email such as confidential, urgent, to be deleted, important, and/or to be ignored), and attempting to change the status of the email (e.g., marking the email as “unread” after accessing the email).

The computing device 201 can generate an immutable identifier for each of the actions or activities in the activity log in the email data server 203. In some embodiments, the immutable identifiers can be generated by an application implemented in the email data server 203. The computing device 201 can then generate metadata (e.g., the metadata portion 109 discussed above in FIG. 1) for each email of the email data based on the custodian actions, and associate the metadata with the immutable identifier. For example, the metadata can indicate a custodian action, a corresponding custodian, and/or the time that the custodian action was performed. The immutable identifiers and the metadata can be stored in the query server 205 (e.g., Step 23 shown in FIG. 2). The computing device 201 can store the immutable identifiers and the content of the emails of the email data (e.g., the raw data portion 111 discussed above in FIG. 1) in the database 207 (e.g., Step 24 shown in FIG. 2).

Based on the immutable identifiers, the system 200 enables an operator to search or query the email data in the query server 205 (e.g., Step 25 shown in FIG. 2). The query server 205 can pull the content of the emails from the database 207 based on the immutable identifiers (e.g., Step 27 shown in FIG. 2), if the operator requests doing so.

In the illustrated embodiments, the computing device 201, the query server 203, and the database 207 can each be implemented as a distributed system across more than one devices connected via a network.

FIG. 3A is a schematic diagram illustrating a data structure of a custodian-based data set 300 in accordance with embodiments of the present technology. As shown, the custodian-based data set 300 includes immutable identifiers 301, a metadata portion 303, and a data portion 305. The immutable identifiers 301 are configured to associate the metadata portion 303 and the data portion 305 such that the data portion 305 can be searched or queried based on the metadata portion 303. In some embodiments, the immutable identifiers 301 can include a serial number, a string, a symbol, an object, a link, and/or other suitable identifiers. The data portion 305 can include email data such as EML files 3051 and corresponding attachments 3052. The data portion 305 can be in binary form.

In some embodiments, the metadata portion 303 can be a JavaScript Object Notation (JSON) message. JSON is a lightweight, text format that is language independent. JSON messages are easy for humans to read and write as well as for machines to parse and generate. The metadata portion 303 can indicate a custodian section 3031, an application section 3032, an action section 3033, and a time section 3034. The custodian section 3031 indicates a custodian of a data piece (e.g., an email, a message, etc.) of the data portion 305. The application section 3032 indicates an application (e.g., Microsoft Outlook) that was used to access the data piece. The action section 3033 indicates a custodian action that was performed to the data piece. The time section 3034 indicates the time that the custodian action was performed.

The immutable identifiers 301 are associated with the sections 3031-3034 such that an operator can search or query the data portion 305 based on these sections 3031-3034. For example, the operator can search all the custodian actions performed by custodian C₁ using Application A₁ during time period T₁. As another example, the operator can search all data pieces that were “marked as unread” by custodian C₂ using application A₂ during time period T₂. By this arrangement, the present technology provides a data structure to store/maintain and search/query the custodian-based data in an efficient and convenient fashion.

FIG. 3B is a table illustrating a query index 307 of a custodian-based data set in accordance with embodiments of the present technology. The query index 307 can be associated with the immutable identifiers 301. As shown in FIG. 3B, the query index 307 includes multiple data items D (only D₁-D₄ are shown in FIG. 3B as examples). Each of the data items D can be associated with one immutable identifier 301. The query index 307 can include multiple columns (or sections, portions, other suitable data forms, etc.) to indicate the content of the data item D. In the illustrated embodiments, columns 3071-3075 are provided as examples. In other embodiments, the query index 307 can include other numbers and types of columns.

As shown in FIG. 3B, custodian column 3071 indicates a custodian of the data item D. In some embodiments, the custodian can be a single person (e.g., a recipient of an email). For example, the custodian of the data item D₁ and the custodian of the data item D₂ are single persons (User A and User B). In some embodiments, the custodian can be a group of people. For example, the custodian of the data item D₃ can be the board of directors of a company. As another example, the custodian of the data item D₄ can be team members in Project X (which involves Technology Y).

Action column 3072 indicates a custodian action that has been performed by the custodian (indicated in the custodian column 3071). Time of action column 3073 indicates the time the custodian action (indicated in the action column 3072) was performed. For example, the query index 307 (in data item D₁) indicates that User A deleted an email (which can be identified by its associated immutable identifiers 301) at “13:59, Mar. 1, 2005.” Similarly, the query index 307 (in data item D₂) indicates that User B marked an email (which can be identified by its associated immutable identifiers 301) as “Unread” at “23:07, Feb. 5, 2010.”

In some embodiments, the custodian action can be an action performed by one person of the group. For example, the query index 307 (in data item D₃) indicates that one of the broad of directors of the company marked an email (which can be identified by its associated immutable identifiers 301) as “Important” at “05:28, Apr. 4, 2019.” In some embodiments, the custodian action can be an action performed by more than two persons of the group. For example, an operator of the present system can customize and define the “custodian action,” such as, “more than two board of directors perform the action,” “a majority of the board of directors performed the action,” etc. In such embodiments, the time of action column 3073 can have multiple data entries.

In some embodiments, the custodian can be determined based on assigned tasks. For example, data item D₄ indicates that one person in Project X stored an attachment of an email (which can be identified by its associated immutable identifiers 301) in “Confidential Folder” at “17:45, Apr. 4, 2020.”

The query index 307 can include multiple attributes to further describe the data items D. For example, “Attribute 1” column 3074 can indicate whether the custodian (indicated in the custodian column 3071) is considered a manager of an organization. As another example, “Attribute 2” column 3075 can indicate whether the custodian (indicated in the custodian column 3071) is involved in a specific type of technology (e.g., Technology Y shown in FIG. 3B) or has access to certain types of information (e.g., an internal discussion of a merger of two companies).

Based on the foregoing arrangements, the query index 307 enables an operator or a user to effectively and efficiently search the custodian-based data discussed herein. For example, the operator or the user can customize search queries that fit particular needs (e.g., a court order, a document production request, a litigation-risk analysis, etc.) and accordingly generate relevant custodian-based data to address the needs.

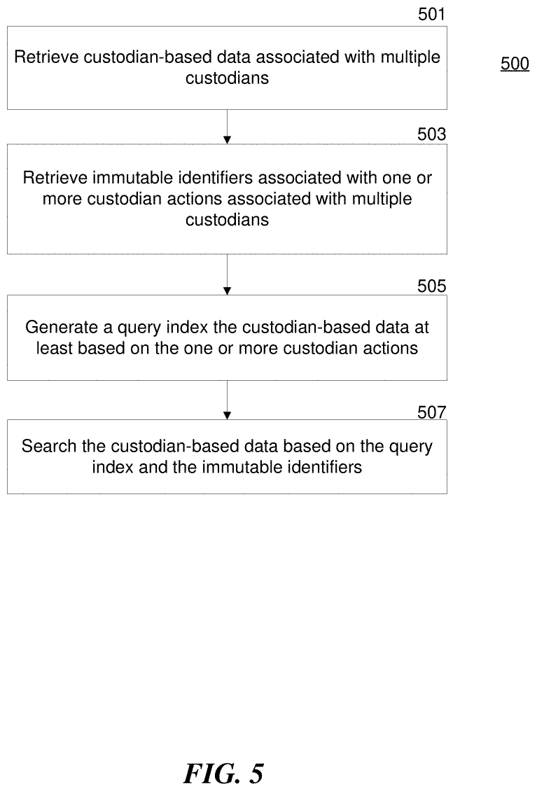

FIG. 4 is a schematic diagram illustrating components in a computing device (e.g., a client device, a server, etc.) in accordance with embodiments of the present technology. The computing device 400 can be implemented as a server, a client device, a distributed computing system, and/or other suitable devices. Examples of the computing device 400 include the computing devices 100, 200 in FIGS. 1 and 2. The computing device 400 is configured to process the methods (e.g., FIGS. 5-7) discussed herein. The illustrated computing device 400 is only an example of a suitable computing device and is not intended to suggest any limitation as to the scope of use or functionality. Other well-known computing systems, environments, and/or configurations that may be suitable for use include, but are not limited to, personal computers (PCs), server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its basic configuration, the computing device 400 includes at least one processing unit 402 and a memory 404. Depending on the exact configuration and the type of computing device, the memory 404 may be volatile (such as RAM), non-volatile (such as ROM, flash memory, etc.), or some combination of the two. This basic configuration is illustrated in FIG. 4 by dashed line 406. Further, the computing device 400 may also include storage devices (a removable storage 408 and/or a non-removable storage 410) including, but not limited to, magnetic or optical disks or tape. Similarly, the computing device 400 can have an input device 414 such as keyboard, mouse, pen, voice input, etc. and/or an output device 416 such as a display, speakers, printer, etc. Also included in the computing device 400 can be one or more communication components 412, such as components for connecting via LAN, WAN, point to point, any other suitable interface, etc.

The computing device 400 can include a data management/query module 418 configured to implement methods for managing and querying custodian-based data. The data management/query module 418 is configured to receive and analyze custodian-based data, store/manage the analyzed custodian-based data, and search the stored custodian-based data. In some embodiments, the data management/query module 418 can be in the form of instructions, software, firmware, as well as a tangible device.

The computing device 400 includes at least some form of computer readable media. The computer readable media can be any available media that can be accessed by the processing unit 402. By way of example, the computer readable media can include computer storage media and communication media. The computer storage media can include volatile and nonvolatile, removable and non-removable media (e.g., removable storage 408 and non-removable storage 410) implemented in any method or technology for storage of information such as computer readable instructions, data structures, program modules or other data. The computer storage media can include, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible medium which can be used to store the desired information.

FIG. 5 is a flow diagram showing a method 500 in accordance with embodiments of the present technology. The method 500 can be implemented by a computing device (e.g., the computing device 101, 201, or 400) or any other suitable devices. The method 500 starts at block 501 by retrieving custodian-based data associated with multiple custodians. In some embodiments, the custodian-based data can include email data. The multiple custodians can include email users, each of which can be identified by an email address (e.g., XYZ@ABC.com).

At block 503, the method 500 continues by retrieving immutable identifiers associated with one or more custodian actions associated with multiple custodians. In some embodiments, the immutable identifiers can be generated based on metadata items of emails.

In some embodiments, for each custodian action, there can be a corresponding immutable identifier. For example, an immutable identifier “ABC-XYZ-20210101-0650PM-ACTION-A1” can be generated for action “A1” performed by custodian “XYZ” of Company “ABC” to a data piece of the custodian-based data at “6:50 p.m.” on “Jan. 1, 2021.” In other embodiments, the immutable identifiers can be in various forms.

At block 505, the method 500 continues by generating a query index the custodian-based data at least based on the one or more custodian actions. In some embodiments, the query index includes one or more data item, and each of the data items of the query index is associated with one of the immutable identifiers. In some embodiments, the query index can include a custodian section, a custodian action section, and a time-of-action section.

In some embodiments, the query index can include an attribute section. The attribute section is indicative of an attribute of a corresponding custodian of the multiple custodians. For example, the attribute can include a status of the corresponding custodian, a group that the corresponding custodian belongs, a task assigned to the corresponding custodian, etc.

At block 507, the method 500 continues to search the custodian-based data based on the query index and the immutable identifiers. In some embodiments, the query index can be customized so as to fit particular needs.

In some embodiments, the custodian-based data can include email data. In some embodiments, the email data can include information in JSON format, information in EML format, an attachment to an email, and/or a link in an email. The multiple custodians can include a sender of an email in the email data and/or a recipient of the email.

In certain examples, the metadata items can include a sender of an email in the email data, a direct recipient of the email, an indirect recipient of the email, a flag identifier of the email, and/or time that the one or more custodian actions are performed to the email.

In some instances, the custodian actions can include (i) deleting an email of the email data; (ii) archiving an email of the email data; (iii) assigning a flag identifier to an email of the email data; and/or (iii) marking an email in the email data as unread after the email is accessed. The flag identifier can be indicative of one or more following statuses of the email: confidential, urgent, to be deleted, important, and/or to be ignored.

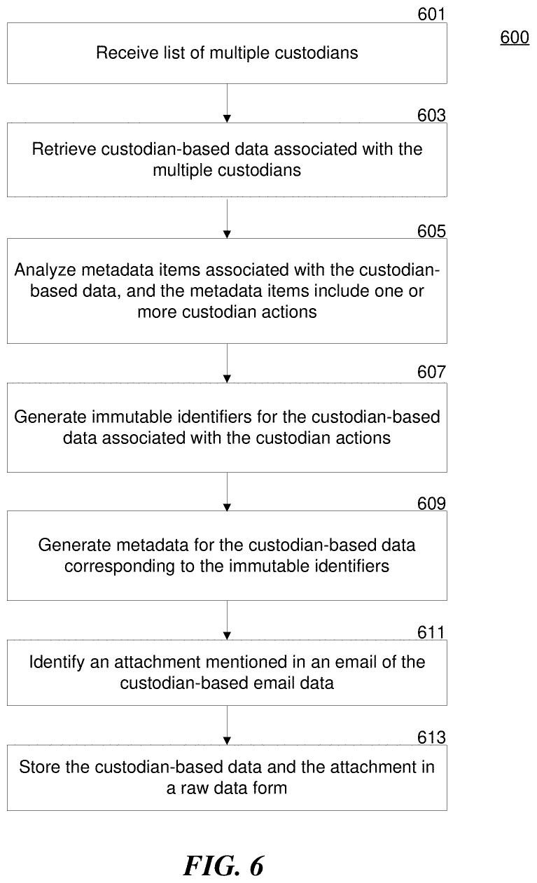

FIG. 6 is a flow diagram showing a method 600 in accordance with embodiments of the present technology. The method 600 can be implemented by a computing device (e.g., the computing device 101, 201, or 400) or any other suitable devices. The method 600 starts at block 601 by retrieving a list of multiple custodians. At block 603, the method 600 continues by retrieving custodian-based data associated with the multiple custodians. At block 605, the method 600 continues to analyze metadata items associated with the custodian-based data. The metadata items can include one or more custodian actions.

At block 607, the method 600 continues by generating immutable identifiers for the custodian-based data associated with the custodian actions. At block 609, metadata is generated for the custodian-based data corresponding to the immutable identifiers. For example, for each custodian action, an immutable identifier can be generated. At block 611, the method 600 includes identifying an attachment associated with an email of the custodian-based email data. At block 613, the method 600 continues by storing the custodian-based data and the attachment in a raw data form.

In some embodiments, the method 600 further includes enabling a query of the custodian-based data based on the custodian actions. In some embodiments, the method 600 further includes (i) retrieving the custodian-based data associated with the multiple custodians in a real-time manner; (ii) verifying whether the attachment associated with the email is included in the custodian-based email data; and/or (iii) in an event that the attachment associated with in the email is not included in the custodian-based email data, retrieving the attachment via a link in the email.

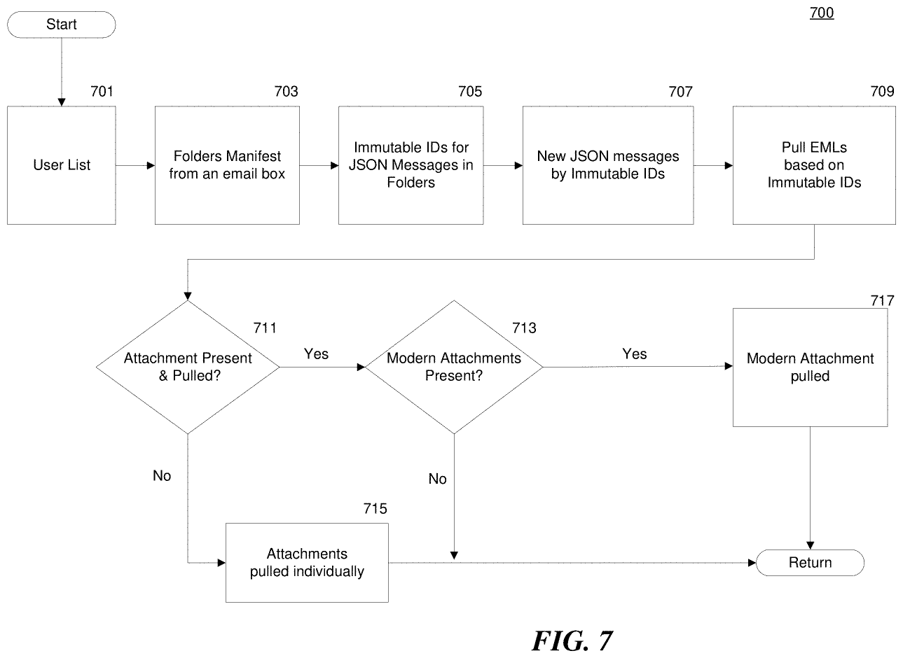

FIG. 7 is a flow diagram showing a method 700 in accordance with embodiments of the present technology. The method 700 can be implemented by a computing device (e.g., the computing device 101, 201, or 400) or any other suitable devices. At block 701, a user list is received. In some embodiments, the user list can include multiple names, account names, titles, email addresses, and/or other suitable information.

At block 703, information regarding “Folders Manifest from an email box” can be retrieved. In some embodiments, “Folders Manifest” can be a text list of file or folder contents of the email box. The information regarding “Folders Manifest” can indicate the number and types of folders that an email account may have. For example, an email account can have a “to be deleted” folder, a “draft” folder, an “important folder,” “to be processed” folder, etc. In some embodiments, the information regarding “Folders Manifest” can be in JSON format.

At block 705, by analyzing the information regarding “Folders Manifest,” immutable identifiers are generated and assigned to actions or items in each folder. At block 707, metadata associated with the immutable identifiers can be generated (e.g., in JSON format, noted as “New JSON messages by Immutable IDs” at block 707. In some embodiments, if an attachment to an email is in text format, it can also be included in the JSON message.

At block 709, the method 700 continues to pull email content (e.g., EML files) based on the generated immutable identifiers. For example, an immutable identifier “ABC-XYZ-19970505-0343AM-UNREAD-A2” can be generated for action “A2” that the custodian “XYZ” of Company “ABC” marked an email as “unread” at “3:43 a.m.” on “May 5, 1997.” The custodian's action was recorded by moving the email from folder “Inbox” to “unread” folder. Based on the immutable identifier corresponding to that email, an EML file of that email can be pulled and stored.

At decision block 711, the method 700 determines whether an attachment associated with the email is already present or pulled. If affirmative, the process moves to block 713. If negative, the process moves to block 715 to individually download that attachment.

At decision block 713, the method 700 determines whether there is a “modern attachment” or a hyperlink attachment associated with the email. The term “modern attachment” refers to a link included in the email and directed to a remote network address or location. For example, a link to a file saved in a cloud server. If affirmative, the process moves to block 717 to download or pull the file indicated by the modern attachment. If negative, the process then returns for further process.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims.

1. A method, comprising:
retrieving custodian-based data associated with multiple custodians;
retrieving immutable identifiers associated with one or more custodian actions associated with the multiple custodians, wherein the immutable identifiers are formed independently of metadata of the one or more custodian actions, wherein the immutable identifiers are associated with information indicative of a management role of the multiple custodians;
generating a query index of the custodian-based data at least based on the one or more custodian actions; and
searching the custodian-based data based on the query index and the immutable identifiers.

2. The method of claim 1, wherein the query index includes one or more data items, and the method further comprises:
associating each of the one or more data items of the query index with one of the immutable identifiers.

3. The method of claim 1, wherein the query index includes a custodian section, a custodian action section, and a time-of-action section.

4. The method of claim 1, wherein the query index includes an attribute section, and wherein the attribute section is indicative of an attribute of a corresponding custodian of the multiple custodians.

5. The method of claim 4, wherein the attribute includes a status of the corresponding custodian.

6. The method of claim 4, wherein the attribute includes a group to which the corresponding custodian belongs.

7. The method of claim 1, wherein the custodian-based data includes email data.

8. The method of claim 7, wherein the multiple custodians include a sender of an email in the email data and/or a recipient of the email.

9. The method of claim 7, wherein the custodian-based data includes one or more data items, and wherein the one or more data items include a sender of an email in the email data, a direct recipient of the email, an indirect recipient of the email, a flag identifier of the email, and/or a time that the one or more custodian actions are performed to the email.

10. The method of claim 7, wherein the one or more custodian actions include deleting an email of the email data.

11. The method of claim 7, wherein the one or more custodian actions include archiving an email of the email data.

12. The method of claim 7, wherein the one or more custodian actions include assigning a flag identifier to an email of the email data.

13. The method of claim 7, wherein each of the immutable identifiers is generated for each of the custodian actions performed to an email in the email data.

14. A method, comprising:
retrieving custodian-based data associated with multiple custodians;
retrieving immutable identifiers associated with one or more custodian actions associated with the multiple custodians, wherein the immutable identifiers are formed independently of metadata of the one or more custodian actions, wherein the immutable identifiers are associated with information indicative of a management role of the multiple custodians;
generating a query index having one or more data items at least based on the one or more custodian actions;
associating each of the data items of the query index with one of the immutable identifiers; and
searching the custodian-based data based on the query index.

15. The method of claim 14, wherein the query index includes a custodian section, a custodian action section, and a time-of-action section.

16. The method of claim 14, wherein the query index includes an attribute section, and wherein the attribute section is indicative of an attribute of a corresponding custodian of the multiple custodians.

17. The method of claim 16, wherein the attribute includes a status of the corresponding custodian.

18. The method of claim 16, wherein the attribute includes a group to which the corresponding custodian belongs.

19. The method of claim 14, wherein the one or more custodian actions include performing an action to an email of the email data.

20. A system, comprising:
one or more processors; and
one or more memory devices having stored thereon instructions that when executed by the one or more processors cause the one or more processors to:
retrieve custodian-based data associated with multiple custodians;
retrieve immutable identifiers associated with one or more custodian actions associated with the multiple custodians, wherein the immutable identifiers are formed independently of metadata of the one or more custodian actions, wherein the immutable identifiers are associated with information indicative of a management role of the multiple custodians;
generate a query index for the custodian-based data at least based on the one or more custodian actions; and
search the custodian-based data based on the query index and the immutable identifiers.
